(19) United States
(12) Patent Application Publication
(10) Pub. No.: US 2015/0272828 A1
(43) Pub. Date: Oct. 1, 2015

(54) INTRAVENOUS BAG LABELING SYSTEM

(71) Applicant: THE BOARD OF TRUSTEES OF THE UNIVERSITY OF ILLINOIS, Urbana, IL (US)

(72) Inventors: Peter Pfanner, Chicago, IL (US); Andrew Graham, Chicago, IL (US); Matthew George Mayfield, Chicago, IL (US); Michael Paradise, Chicago, IL (US); April Anne Starr, Riverside, IL (US); Peter Nelson, Wilmette, IL (US)

(21) Appl. No.: 14/432,893

(22) PCT Filed: Sep. 30, 2013
(86) PCT No.: PCT/US2013/062687

§ 371 Date: Apr. 1, 2015

Related U.S. Application Data
(60) Provisional application No. 61/710,431, filed on Oct. 5, 2012.

(51) Int. Cl. A61J 1/18; G09F 3/04; A61J 1/10

(52) U.S. Cl. CPC A61J 1/18; A61J 1/10; G09F 3/04; A61J 2205/20; G09F 2003/0272

(57) ABSTRACT

An intravenous bag for use with an intravenous line includes a fluid cavity, a flange at least partially surrounding the fluid cavity, and one or more identification tags removably coupled to the flange without compromising the integrity of the fluid cavity. At least one of the identification tags is associated with contents of the fluid cavity and is attachable to the intravenous line for associating the intravenous line with the contents of the fluid cavity.

### CROSS-REFERENCE TO RELATED APPLICATIONS

This application claims priority to co-pending U.S. Provisional Patent Application No. 61/710,431 filed on Oct. 5, 2012, the entire content of which is incorporated herein by reference.

### FIELD OF THE INVENTION

The present invention relates generally to intravenous bags, and more particularly to labeling systems for intravenous bags.

### BACKGROUND OF THE INVENTION

Intravenous systems deliver fluid to a patient in a hospital, clinic, operation, or emergency situation. An intravenous system includes an intravenous infusion bag (hereinafter referred to as “IV Bag”) and an intravenous line (hereinafter referred to as “IV line”) connected to the bottom of the IV bag. The other end of the IV line may be connected to a needle or an insertion apparatus, a portion of which is inserted intravenously into the patient. The IV line may also be connected to a pump apparatus that monitors the flow of fluids and directs the fluids into a patient intravenously.

A variety of different fluids may be administered to a patient. Also, one patient may receive a variety of fluids simultaneously. Often, each IV bag is detachably connected to a clear plastic IV line. The IV bags containing multiple fluids are often hung from an apparatus so that gravity may assist the flow. Typically the IV bags are clear with writing on them indicating their contents. Accordingly, a quick glance at the IV bags does not differentiate them.

The inability to differentiate the IV bags quickly and efficiently is problematic, since health care providers and technicians must be able to recognize the IV bags and determine their contents. Knowing which IV bag is which assists the health care providers in monitoring the flow of each IV bag individually. At times a syringe may be used to inject an additive, such as a medication to a bag or its line, and this information should be identified on the IV bag. Often, additional information may also be included on the IV bag itself, such as when it was connected, and how much fluid should be delivered to the patient.

Traditionally, IV bags may be identified by adhering tape, or some sort of pressure sensitive label. Tape may be problematic because it is not rigid and it is difficult to write upon. Tape also doesn't allow much of a surface area to write upon, since it is wrapped around the line. Tape traditionally also leaves behind an adhesive residue, which can be unsanitary as it may attract dirt and bacteria to stick to the adhesive surface. Other pressure sensitive labels may also be problematic for similar reasons.

Alternative labeling systems may include a rigid tag that may attach to the IV line. Such a rigid tag may also be problematic because the means for attaching the rigid tag may create pressure on the IV line, thus compromising the flow of the fluid. Also, the IV labeling tag is a completely separate member from the IV bag, thus relying on human error to fill in the correct corresponding information on the IV tag. Since none of these mentioned systems come as a part of the IV bag itself, error and mislabeling may always be an issue.

### SUMMARY OF THE INVENTION

Accordingly, a need exists for an intravenous bag labeling system that includes a removable tag having means to be attached to the intravenous line which intrinsically corresponds to the intravenous bag as described and claimed herein.

The invention provides, in one aspect, an intravenous bag for use with an intravenous line. The intravenous bag includes a fluid cavity, a flange at least partially surrounding the fluid cavity, and one or more identification tags removably coupled to the flange without compromising the integrity of the fluid cavity. At least one of the identification tags is associated with contents of the fluid cavity and is attachable to the intravenous line for associating the intravenous line with the contents of the fluid cavity.

The invention provides, in another aspect, an intravenous system. The intravenous system includes an intravenous bag having a fluid cavity and a flange at least partially surrounding the fluid cavity. The intravenous system also includes one or more identification tags removably coupled to the flange without compromising the integrity of the fluid cavity, at least one of the identification tags being associated with contents of the fluid cavity, and an intravenous line extending from the intravenous bag and in fluid communication with the fluid cavity. The identification tag is attachable to the intravenous line for associating the intravenous line with the contents of the fluid cavity.

Other features and aspects of the invention will become apparent by consideration of the following detailed description and accompanying drawings.

### BRIEF DESCRIPTION OF THE DRAWINGS

FIG. 1 illustrates an intravenous bag in accordance with an embodiment of the invention.

FIG. 2 illustrates the intravenous bag of FIG. 1 with an identification tag removed.

FIG. 3 illustrates the identification tag of FIG. 2 coupled to an IV line.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

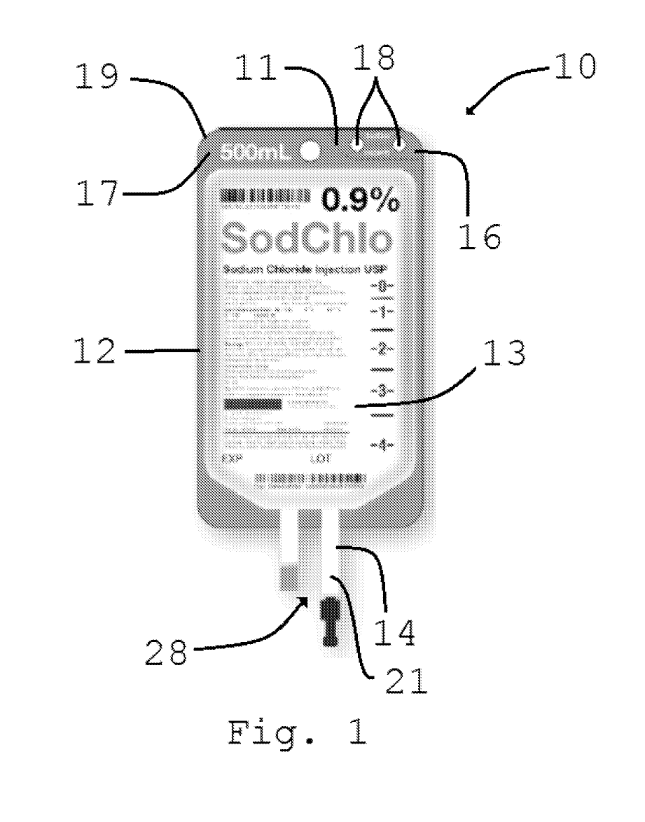

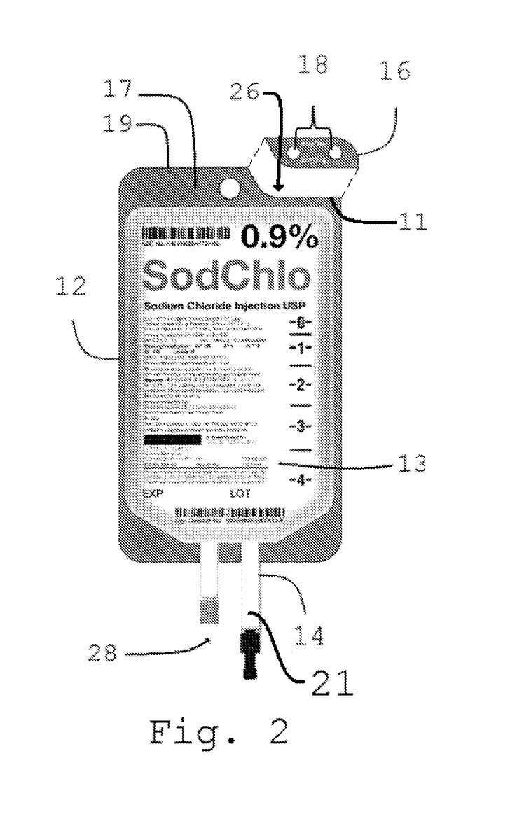

FIGS. 1-3 illustrate one embodiment of an intravenous bag labeling system 10 of the invention. As shown in FIG. 1, the intravenous bag labeling system 10 includes an IV bag 12 defining a fluid cavity 13, an IV line 14, and a removable identification tag 16. The IV line 14 descends from the bottom of the IV bag 12 and is in fluid communication with the fluid cavity 13. In the example shown in FIG. 2, the removable tag 16 has been detached from the IV bag 12.

As shown in FIG. 1, the identification tag 16 can be removed without compromising the fluid integrity of the bag 12 (e.g., by rupturing the fluid cavity 13) or the ability of the bag 12 to be hung from a support stand (not shown). In the some embodiments, the tag 16 may be located proximate a corner of the IV bag 12. Once the tag 16 is removed from the IV bag 12, it may be affixed to the IV line 14, therefore matching the IV bag 12 and the IV line 14.

Illustrated in FIG. 1, the tag 16 is interconnected to the bag 12 by a perforated line 11. As such, the tag 16 may be separated from the IV bag 12 using minimal force and with a tearing action. However, the tag 16 is incorporated into and formed from the same material as the IV bag 12 itself, so the tag 16 may not accidentally separate from the bag 12, but rather would require an intentionally applied force to be separated from the bag 12. In the illustrated embodiment, the perforated line 11 defines at least a portion of the shape of the tag 16. As shown in FIGS. 1 and 2, the IV bag 12 includes a flange 17 surrounding the fluid cavity 13 and defining an outer peripheral boundary 19. In the illustrated embodiment of the bag 12, the tag 16 is formed as a part of the flange 17 and is contained within the outer peripheral boundary 19 (FIG. 1). As such, when the tag 16 is removed from the bag 12, the shape of the peripheral boundary 19 (or the silhouette of the bag 12) is changed, creating a cutout 26 (FIG. 2). The resulting cutout 26 provides a visual representation that the IV bag 12 is actively in use. The shape of the cutout 26 may also be used to help match a particular bag 12 with a particular tag 16 and IV line 14. Alternatively, the perforated line 11 may deviate from the shape illustrated in FIGS. 1 and 2, in which case the tag 16 may only be partially located within the outer peripheral boundary 19 of the flange 19. As a further alternative, the tag 16 may be wholly located outside the outer peripheral boundary 19 of the flange 17. In yet another alternative embodiment, the tag 16 may be attached to the bottom of the bag 12 adjacent the IV line 14, with the IV line 14 pre-threaded through the holes 18 of the tag 16. In such an embodiment, the tag 16 may be separated from the bag 12 and slid down the IV line 14 into a desired position. In yet another alternative embodiment, the bag 12 may include a plurality of tags 16 in any combination of the above described constructions; for example, the bag 12 may include a tag 16 positioned proximate the top corner of the flange 17 and a second tag 16 near the bottom of the bag 12.

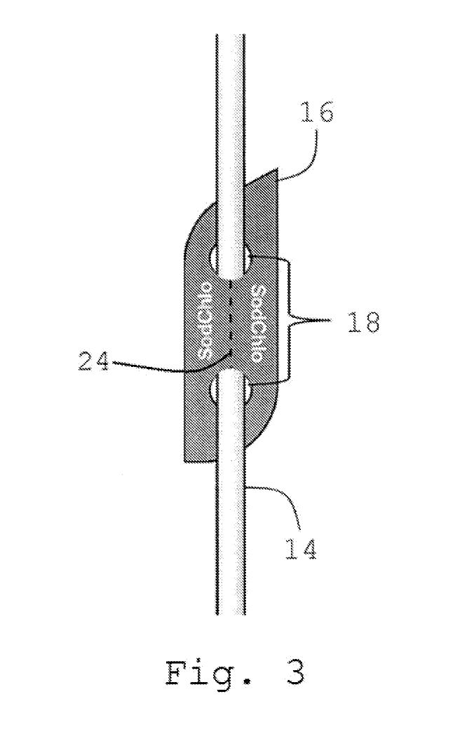

As shown in FIG. 3, the identification tag 16 includes a pair of apertures 18, one located on each end of the tag 16, for threading the IV line 14 there through for securing the tag 16 to the IV line 14 without an adhesive material. As would be understood by one of ordinary skill in the art, the IV line 14 shown in FIG. 3 is an extension of the IV line 14 shown in FIGS. 1 and 2 that is connectable to the IV bag 12 by an fitting 21. Accordingly, the tag 16 may be positioned on the IV line 14 somewhere remote from the IV bag 12. Furthermore, the tag 16 may include a slot 24 extending between the apertures 18. The slot 24 allows the tag 16 to be removably coupled to the IV line 14 without having to thread the IV line 14 through the apertures 18. As such, the tag 16 may be attached anywhere along the IV line 14 by inserting the line 14 between separated portions of the tag 16 adjacent the slot 24, without having to disconnect one end of the IV line 14 first (e.g., when the IV line 14 is already in place on a patient or has a needle attached thereto). In still other embodiments, a perforated line may extend between the apertures 18 so that the tag 16 initially must be thread onto the IV line 14, but later can be separated from the line 14 by tearing the perforated line and therefore creating the slot 24.

It is contemplated that in other embodiments the removable tag 16 may be coupled to the IV line 14 in any other way. For example, the removable tag 16 may be affixed to the IV line 14 with an adhesive. One side of the removable tag 16 may include an adhesive backing so that it may be stuck to a portion of the IV line 14. In another example, the IV tag 16 may be tied to the IV line 14 using some additional attachment means.

The IV bag 12 and removable tag 16 may also have matching indicia so that they may be easily associated. For example, when a health care provider sees a tag 16 on an IV line 14, they will know immediately with which IV bag 12 that particular IV line 14 corresponds by the design and/or shape of the tag 16. In the example shown in FIG. 1, the tag 16 and portions of the IV bag 12 (e.g., the flange 19) are the same color, so they may be identified easily. However in other embodiments, the IV bag 12 and corresponding tag 16 may have matching shapes, text, barcodes, or other markings.

In the illustrated embodiment, the flange 17 of the IV bag 12 is a different color than the remainder of the bag 12. In such an embodiment, the tag 16 and the flange 17 are formed with a matching color. Furthermore, the bag 12 may include indicia indicating the contents of the bag 12 written in large text of that same color.

The surface of the IV bag 12 and tag 16 may also be composed of a material that may be written upon using any ink, so that a health care provider may label the IV bag 12 and tag 16 accordingly. Therefore, if an additive is injected into the IV bag 12, the health care provider may indicate that addition on the IV bag 12 and IV line 14 (i.e., by further labeling the tag 16).

The IV bag 12 may be manufactured using a thermo-forming process in which a piece of sheet material (e.g., PVC plastic) is sealed along the edges to at least partially define the fluid cavity 13 and at least partially form the flange 17. During the sealing process, the perforated line 11 may be stamped or otherwise formed into the flange 17 to define at least a portion of the perimeter of the identification tag 16. In alternative embodiments, the perforated line 11 may be formed at another time than the sealing process.

An advantage of the intravenous bag labeling system 10 is that the IV bag 12 and removable tag 16 correspond to each other creating an efficient identification system 10.

Another advantage of the intravenous bag labeling system 10 is that the removable tag 16 may be easily removed and attached to the IV line 14.

Another advantage of the intravenous bag labeling system 10 is that it ensures that health care providers can easily see what fluids are entering the patient.

A further advantage of the intravenous bag labeling system 10 is that the removal of the tag 16 creates an additional point of safety through the behavior of physically labeling the IV line 14.

It should be noted that various changes and modifications to the presently preferred embodiments described herein will be apparent to those skilled in the art. Such changes and modifications may be made without departing from the spirit and scope of the present invention and without diminishing its attendant advantages.

Various features of the invention are set forth in the following claims.

What is claimed is:

1. An intravenous bag for use with an intravenous line, the intravenous bag comprising:
a fluid cavity;
a flange at least partially surrounding the fluid cavity; and
one or more identification tags removably coupled to the flange without compromising the integrity of the fluid cavity, wherein at least one of the identification tags is associated with contents of the fluid cavity, and wherein the identification tag is attachable to the intravenous line for associating the intravenous line with the contents of the fluid cavity.

2. The intravenous bag of claim 1, wherein the identification tag includes an aperture through which the intravenous line is receivable for attaching the identification tag to the intravenous line.

3. The intravenous bag of claim 2, wherein the aperture is a first aperture, and wherein the identification tag further includes a second aperture through which the intravenous line is receivable.

4. The intravenous bag of claim 1, further comprising a perforated line interconnecting the flange and the identification tag, wherein the identification tag is removable from the flange by separating the identification tag from the flange along the perforated line.

5. The intravenous bag of claim 4, wherein at least one of a size and a shape of the identification tag is at least partially defined by the perforated line.

6. The intravenous bag of claim 1, further comprising indicia indicating the contents of the fluid cavity both on the identification tag and a portion of the intravenous bag coinciding with the fluid cavity.

7. The intravenous bag of claim 6, wherein the indicia includes at least one of color and text.

8. The intravenous bag of claim 1, wherein the flange includes an outer peripheral boundary, and wherein the identification tag is contained within the outer peripheral boundary of the flange.

9. The intravenous bag of claim 8, wherein a cutout is created in the flange having a shape at least partially coinciding with that of the identification tag when the identification tag is removed from the flange.

10. An intravenous system comprising:
an intravenous bag having a fluid cavity and a flange at least partially surrounding the fluid cavity;
one or more identification tags removably coupled to the flange without compromising the integrity of the fluid cavity, at least one of the identification tags being associated with contents of the fluid cavity; and
an intravenous line extending from the intravenous bag and in fluid communication with the fluid cavity, wherein the identification tag is attachable to the intravenous line for associating the intravenous line with the contents of the fluid cavity.

11. The intravenous system of claim 10, wherein the intravenous bag and the identification tag are integrally formed as a single piece.

12. The intravenous system of claim 10, wherein the identification tag includes an aperture through which the intravenous line is receivable for attaching the identification tag to the intravenous line.

13. The intravenous system of claim 12, wherein the aperture is a first aperture, and wherein the identification tag further includes a second aperture through which the intravenous line is receivable.

14. The intravenous system of claim 10, wherein the intravenous bag and the identification tag are interconnected by a perforated line, and wherein the identification tag is removable from the flange by separating the identification tag from the flange along the perforated line.

15. The intravenous system of claim 10, wherein at least one of a size and a shape of the identification tag is at least partially defined by the perforated line.

16. The intravenous system of claim 15, wherein the identification tag and at least a portion of the intravenous bag are substantially the same color.

17. The intravenous system of claim 10, further comprising indicia indicating the contents of the fluid cavity both on the identification tag and a portion of the intravenous bag coinciding with the fluid cavity.

18. The intravenous system of claim 17, wherein the indicia includes at least one of color and text.

19. The intravenous system of claim 10, wherein the flange includes an outer peripheral boundary, and wherein the identification tag is contained within the outer peripheral boundary of the flange.

20. The intravenous system of claim 10, wherein a cutout is created in the flange having a shape at least partially coinciding with that of the identification tag when the identification tag is removed from the flange.
